(19) United States
(12) Patent Application Publication
(10) Pub. No.: US 2011/0214775 A1
(43) Pub. Date: Sep. 8, 2011

(54) CYLINDER TUBE, HYDRAULIC CYLINDER WITH SAME, AND METHOD OF MANUFACTURING CYLINDER TUBE

(75) Inventor: Kouzou Yano, Osaka (JP)

(73) Assignee: KOMATSU LTD., Tokyo (JP)

(21) Appl. No.: 13/126,545

(22) PCT Filed: Oct. 26, 2009
(86) PCT No.: PCT/JP2009/068354

§ 371 Date: Apr. 28, 2011

(30) Foreign Application Priority Data
Nov. 17, 2008 (JP) 2008-292887

(51) Int. Cl. F16L 9/00; B21J 5/06

(52) U.S. Cl. 138/171; 219/153

(57) ABSTRACT

A cylinder tube of a hydraulic cylinder includes a substantially cylindrical outer peripheral wall portion, a port hole, and a plurality of rigidity changing portions. The port hole is formed in a part of the outer peripheral wall portion to communicate with an interior space of the outer peripheral wall portion. The rigidity changing portions are arranged at positions spaced at about 90 degrees leftward and rightward away from the port hole in the circumferential direction as viewed in section, with each of the rigidity changing portions having cross-sectional rigidity larger than a part in proximity to the port hole.

### CROSS-REFERENCE TO RELATED APPLICATIONS

This national phase application claims priority to Japanese Patent Application No. 2008-292887 filed on Nov. 17, 2008. The entire disclosure of Japanese Patent Application No. 2008-292887 is hereby incorporated herein by reference.

### TECHNICAL FIELD

The present invention relates to a cylinder tube that composes a hydraulic cylinder used for construction machines and the like, a hydraulic cylinder including this cylinder tube, and a method of manufacturing a cylinder tube.

### BACKGROUND ART

Generally, hydraulic cylinders used for construction machine and the like are composed of a combination of a cylinder tube and a bottom member. A port hole is formed on the outer peripheral surface of the cylinder tube, and is connected to a metal joint as branch coupling member.

For example, Japanese Patent Laid-Open Publication No. 2000-009107 (published on Jan. 11, 2000) discloses a cylinder tube strengthening method that forming, in a hydraulic cylinder including a cylinder tube and a bottom member that are integrally coupled to each other, a thicker welded portion on the surface portion of the coupling part between the cylinder tube and the bottom member whereby applying parts in proximity to the welded portion with a contracting force that is produced when the welded thicker portion is solidified. According to this method, fatigue strength can be improved in the welded portion between the cylinder tube and the bottom member without increasing manufacturing cost.

Also, Japanese Patent Laid-Open Publication No. 2004-278346 (published on Oct. 7, 2004) discloses a coupling structure in that, in order to increase the strength of a part in proximity to a port hole of a cylinder tube, the width or the like of a flat portion arranged on the inner peripheral wall surface part of the port hole is specified lager than the maximum width or the like of a fillet in a coupling part of the branch coupling member.

Also, Japanese Patent Laid-Open Publication No. 2004-067061 (published on Mar. 4, 2004) discloses a cylinder tube that has an opening as the port hole that is shaped in combined-semicircular shape so that it is avoided that a stress concentratedly applied to a part around the hole whereby increasing the resistance-to-pressure life of the cylinder tube.

### SUMMARY

However, the aforementioned known cylinder tubes have the following problems.

That is, the cylinder tubes disclosed in the above publications have structures that directly reinforce a part to be reinforced, for example, the coupling part between the cylinder tube and the bottom member, the parts in proximity to the port hole formed in the cylinder tube, and the like.

Specifically, the cylinder tubes disclosed in the above publications adopt reinforcement measures by forming the welded thicker portion or the like in the part around the coupling part, by forming the reinforcement portion directly on a part in proximity to the port hole, and by forming the port hole into the combined-semicircular shape, and the like.

However, since cylinder tube deformation when internal pressure is produced is not taken into consideration in these reinforcement structures, in the case of some deformation degrees or some shapes of a cylinder tube, it may not ensure that fatigue strength is provided on the inner periphery of the port hole of the cylinder tube.

The following description describes the reason that the inner peripheral portion of the port hole of the cylinder tube has a particularly large influence on fatigue strength.

That is, on comparison between the inner and outer peripheral portions of the port hole, the outer peripheral portion of the port hole can be chamfered by a grinder or the like to remove a part where a stress is concentratedly applied, but interference of a tool or the like makes it difficult to remove such a part where a stress is concentratedly applied from the inner peripheral portion of the port hole. For this reason, when fatigue tests are conducted, fatigue fractures starting from the edge of the inner periphery of the port hole are likely to occur.

It is an object of the present invention to provide a cylinder tube capable of improving fatigue strength on the inner periphery side of a port hole in the cylinder tube without directly reinforcing a part in proximity to the port hole, a hydraulic cylinder including this cylinder tube, and a method of manufacturing this cylinder tube.

A cylinder tube according to a first aspect of the present invention is a cylinder tube of a hydraulic cylinder that includes a substantially cylindrical outer peripheral wall portion, a port hole, and a rigidity changing portion. The port hole is formed in a part of the outer peripheral wall portion to communicate with the interior space of the outer peripheral wall portion. The rigidity changing portion is arranged at a position spaced in the circumferential direction away from the port hole as viewed in section, and has cross-sectional rigidity larger than a part in proximity to the port hole.

According to this construction, in a cylinder tube that composes a hydraulic cylinder with a port hole communicating with the interior space of the outer peripheral wall portion, a rigidity changing portion is arranged at a position spaced in the circumferential direction away from the port hole as viewed in section and has rigidity larger than a part in proximity to the port hole.

In this construction, the rigidity changing portion serves to produce a compression stress resulting from a bending stress in a part on the inner peripheral surface of the port hole when an internal pressure is applied to the cylinder tube whereby relieving a tensile stress resulting from the internal pressure. The rigidity changing portion facilitates deformation of the cylinder tube into an oval shape in section. It is noted that the rigidity changing portion can include a portion of the steel tube thickness of which is increased to increase rigidity, a portion the rigidity of which is relatively increased by reducing the thickness of a part in proximity to the port hole, and the like. Alternatively, the rigidity changing portion can be formed by partially using a material with a Young's modulus different from the material of the outer peripheral wall portion. In this case, the outer peripheral wall portion may have a uniform thickness over the rigidity changing portion and the rest of the outer peripheral wall portion. In this case, for example, the rigidity changing portion can be formed by using welding wire with a Young's modulus higher than the base material of the outer peripheral wall portion. Also, two the rigidity changing portions can be formed at positions spaced in the circumferential direction at the same interval leftward and rightward away from the port hole. Also, the rigidity changing portion can be continuously or intermittently formed on the outer periphery wall surface along the longitudinal direction of the cylinder tube.

Accordingly, when an internal pressure is produced in the hydraulic cylinder, the cylinder tube can be deformed into a desired oval shape as viewed in section. At this time, a compression stress is produced by the deformation into a desired oval shape and acts on an area on the inner peripheral surface side of the port hole so that a tensile stress produced by the internal pressure can be reduced. Thus, this construction facilitates deformation of the outer peripheral wall portion into a desired oval shape when an internal pressure is produced without directly reinforcing a part in proximity to the port hole or forming the hole into a complicatedly devised shape, and as a result can relieve, on the inner periphery side of the port hole, a tensile stress that may cause fatigue strength reduction. Consequently, it is possible to prevent that cracks and the like appear on the inner periphery side of the port hole, and to improve the fatigue strength of the cylinder tube.

In a cylinder tube according to a second aspect of the present invention, in the cylinder tube according to the first aspect of the present invention, the rigidity changing portion is a thicker portion that has a larger thickness increasing toward the outer diameter side in the outer peripheral wall portion, and extends along the longitudinal direction of the cylinder tube.

According to this construction, the thickness of a part of the outer peripheral wall portion is increased so that this thicker part serves as the rigidity changing portion.

In this construction, the thicker portion as the rigidity changing portion can be previously formed thickly when the steel tube is formed, or can be formed, after a steel tube with uniform thickness is formed, by adding a material onto the steel tube.

Accordingly, when an internal pressure is produced in the cylinder tube, the cylinder tube can be deformed into a desired oval shape whereby relieving a tensile stress in a part in proximity to the port hole. Therefore, it is possible to avoid occurrence of problems that cracks and the like appear in a part in proximity to the port hole.

In a cylinder tube according to a third aspect of the present invention, in the cylinder tube according to the first aspect of the present invention, the rigidity changing portion includes a welding bead that is formed on the outer peripheral surface of the outer peripheral wall portion along the longitudinal direction of the cylinder tube.

According to this construction, the material part of the cylinder tube and the welding bead formed in welding are used as the rigidity changing portion.

In this construction, for example, the aforementioned welding bead part can be a bead part formed when sectionally substantially semicircular members are coupled to each other by welding, or a welded part that is formed by adding a material onto a part of a sectionally circular cylinder tube.

In this case, the rigidity changing portion can be easily formed only by leaving a welding bead formed in a welding process as it is. It is noted that, in order that the cylinder tube can deform into a desired oval shape when an internal pressure is produced, the welded part is only required to be arranged at a desired position relative to the port hole.

In a cylinder tube according to a fourth aspect of the present invention, in the cylinder tube according to any of the first to third aspects of the present invention, the rigidity changing portions are arranged at positions that are spaced at about 90 degrees leftward and rightward away from the port hole as viewed in section.

In this construction, the rigidity changing portions are arranged at positions that are spaced leftward and rightward at about 90 degrees relative to the position of the port hole in the circumferential direction.

According to this construction, since it is possible to increase the rigidity of a part where the rigidity changing portion is formed, a compression stress will be produced in a part on the inner peripheral surface side in proximity to the port hole. Therefore, it is possible to relieve a tensile stress that may produce cracks and the like. As a result, the cylinder tube can deform into a desired oval shape when an internal pressure is produced. Therefore, it is possible to effectively relieve a stress in a part in proximity to the port hole, and to avoid that cracks and the like appear.

In a cylinder tube according to a fifth aspect of the present invention, in the cylinder tube according to any of the first to fourth aspects of the present invention, the rigidity changing portion is formed in a smoothly-curved shape as viewed in section.

In this construction, a smoothly-curved shape is used as the shape of the rigidity changing portion.

According to this construction, it is possible to control the oval shape of the cylinder tube when an internal pressure is produced so that it is prevented that cracks appear in a part in proximity to the port hole. In addition to this, it is possible to avoid that a stress is concentratedly produced in a part where the rigidity changing portion is formed, which in turn cause appearance of cracks and the like.

In a cylinder tube according to a sixth aspect of the present invention, in the cylinder tube according to any of the first to fifth aspects of the present invention, the outer peripheral wall portion is formed by coupling sectionally substantially semicircular members to each other by welding.

In this construction, the cylinder tube is formed by joining two substantially semicircular members to each other by welding.

According to this construction, the welding bead is left that is formed when the sectionally substantially semicircular members are welded to each other so that the aforementioned rigidity changing portion can be easily formed in a typical manufacturing process. For this reason, the rigidity changing portion can be formed without an additional manufacturing process for forming the rigidity changing portion. Therefore, it is possible to simplify manufacturing processes and to reduce the manufacturing cost.

In a cylinder tube according to a seventh aspect of the present invention, in the cylinder tube according to the sixth aspect of the present invention, the rigidity changing portion is a stepped bending portion that is formed in a bended shape on the coupled part of the sectionally substantially semicircular member.

In this construction, a stepped bending portion is arranged on the coupling part of the sectionally substantially semicircular members jointed to each other by welding.

In this case, the portion with stepped shape can include a bent part that is formed along the longitudinal direction of the steel tube to be formed by joining the sectionally substantially semicircular members to each other by welding, and has a flat part to come in surface contact with another flat part when the sectionally substantially semicircular members are opposed to each other, and the like.

According to this construction, in a cylinder tube that is constructed by joining sectionally substantially semicircular members to each other, the rigidity changing portion can be easily formed, and in addition to this, for example, in the case where a beveling part for welding is formed in the stepped bending portion, it is possible to more firmly join the sectionally substantially semicircular members to each other by welding.

In a cylinder tube according to an eighth aspect of the present invention, in the cylinder tube according to the first or second aspect of the present invention, the outer peripheral wall portion is formed from a steel tube that is formed by drawing.

In this construction, the outer peripheral wall portion of the cylinder tube is formed from a steel tube that is formed by drawing.

In this case, when a material such as welding wire is added onto a predetermined position on the outer periphery wall surface of the steel tube so that a welding bead (rigidity changing portion) is formed, it is possible to provide a cylinder tube with excellent fatigue strength.

In a cylinder tube according to a ninth aspect of the present invention, in the cylinder tube according to the eighth aspect of the present invention, the rigidity changing portion is intermittently formed along the longitudinal direction of the steel tube.

In this construction, the rigidity changing portion such as welding bead is intermittently arranged along the longitudinal direction of the steel tube.

In this case, even in the case where the rigidity changing portion is not continuously formed along the longitudinal direction of the steel tube, for example, when the rigidity changing portion is arranged only at a position corresponding to the port hole, it is possible to provide the aforementioned cylinder tube with excellent fatigue strength.

In a cylinder tube according to a tenth aspect of the present invention, in the cylinder tube according to the eighth or ninth aspect of the present invention, the rigidity changing portions are arranged at positions that are spaced at about 90 degrees leftward and rightward away from the port hole as viewed in section.

According to this construction, the rigidity changing portions are arranged at positions that are spaced leftward and rightward at about 90 degrees relative to the position of the port hole in the circumferential direction.

According to this construction, since it is possible to increase the rigidity of a part where the rigidity changing portion is formed, a compression stress will be produced in a part on the inner peripheral surface side in proximity to the port hole when an internal pressure is produced. Therefore, it is possible to relieve a tensile stress that may produce cracks and the like. As a result, the cylinder tube can deform into a desired oval shape when an internal pressure is produced. Therefore, it is possible to effectively relieve a stress in a part in proximity to the port hole, and to avoid that cracks and the like are produced.

In a cylinder tube according to an eleventh aspect of the present invention, in the cylinder tube according to the eighth or ninth aspect of the present invention, the rigidity changing portion is formed in a smoothly-curved shape as viewed in section.

In this construction, a smoothly-curved shape is used as the shape of the rigidity changing portion.

According to this construction, it is possible to control the oval shape of the cylinder tube when an internal pressure is produced so that it is prevented that cracks are produced in a part in proximity to the port hole. In addition to this, it is possible to avoid that a stress is concentratedly produced in a part where the rigidity changing portion is formed, which in turn cause occurrence of cracks and the like.

A hydraulic cylinder according to a twelfth or thirteenth aspect of the present invention includes the cylinder tube according to any of the first to eleventh aspects of the present invention, and a bottom member that is secured to one end of the cylinder tube by welding.

According to this construction, it is possible to provide a hydraulic cylinder that includes the cylinder tube the fatigue strength of which is improved as stated above.

A method of manufacturing a cylinder tube according to a fourteenth aspect of the present invention is a method of manufacturing a cylinder tube of a hydraulic cylinder having a port hole. The method includes the following steps. In the first step, a flat plate-shaped material is formed into a sectionally substantially semicircular member. In the second step, two the sectionally substantially semicircular members are opposed to each other to form a pipe-shaped member. In the third step, the sectionally substantially semicircular members arranged to form a pipe-shaped member are coupled to each other by welding. In the fourth step, the port hole is formed at a position spaced in the circumferential direction away from parts of the substantially semicircular members coupled to each other by welding.

It is noted that the step for forming the port hole can be performed between other steps, and the step for forming the port hole is not necessarily performed in this order.

In this construction, in order to form a cylinder tube of a hydraulic cylinder, a flat plate-shaped material is first bent to form a sectionally substantially semicircular member. The sectionally substantially semicircular members are then arranged to form a pipe-shaped member, and joined to each other by welding. In addition, a port hole is formed at a position spaced in the circumferential direction away from parts coupled to each other by welding of the substantially semicircular members.

According to this construction, after the sectionally substantially semicircular members are joined to each other by welding, a welding bead is formed in the welded part. This welding bead is left as it is and is used as the rigidity changing portion whereby facilitating deformation of the cylinder tube into a desired oval shape when an internal pressure is produced. As a result, it is possible to relieve a stress in the part in proximity to the port hole of the cylinder tube as a product, and to improve the fatigue strength of the cylinder tube.

A method of manufacturing a cylinder tube according to a fifteenth aspect of the present invention is a method of manufacturing a cylinder tube of a hydraulic cylinder having a port hole. The method includes the following steps. In the first step, a steel tube is formed by drawing. In the second step, a rigidity changing portion is formed at a predetermined position on the steel tube. In the third step, the port hole is formed at a position on the outer peripheral surface of the steel tube spaced in the circumferential direction away from the rigidity changing portion.

It is noted that the step for forming the port hole can be performed between other steps, and the step for forming the port hole is not necessarily performed in this order.

In this construction, in order to form a cylinder tube of a hydraulic cylinder, a steel tube is first formed by drawing. A rigidity changing portion such as welding bead is then formed at a predetermined position on the outer peripheral surface of the steel tube. In addition, a port hole is formed at a position spaced in the circumferential direction away from the rigidity changing portion.

According to this construction, since a welding bead or the like is arranged on the outer peripheral surface of the steel tube and serves as the rigidity changing portion, it is possible facilitate deformation of the cylinder tube into a desired oval shape when an internal pressure is produced. As a result, it is possible to relieve a stress in the part in proximity to the port hole of the cylinder tube as a product, and to improve the fatigue strength of the cylinder tube.

### BRIEF DESCRIPTION OF DRAWINGS

FIG. 1 is a cross-sectional view showing the construction of a hydraulic cylinder including a cylinder tube according to an embodiment of the present invention.

FIG. 2 is a perspective view showing the construction of the cylinder tube included in the hydraulic cylinder shown in FIG. 1.

FIG. 3(a) is a cross-sectional view showing a cylinder tube with semicircular members being opposed to each other whereby forming beveling parts. FIG. 3(b) is a cross-sectional view showing the cylinder tube after the beveling parts of the cylinder tube shown in FIG. 3(a) are welded to each other so that welding beads are formed.

FIG. 4(a) is a cross-sectional view showing deformation of a conventional perfectly circular cylinder tube when an internal pressure is applied. FIG. 4(b) is a cross-sectional view showing the cylinder tube shown in FIG. 2 deformed into an oval shape when an internal pressure is applied.

FIGS. 5(a) to 5(e) are perspective views showing manufacturing processes of a cylinder tube.

FIGS. 6(a) to 6(c) are views illustrating a process where the semicircular member is formed from a steel plate by using a press.

FIGS. 7(a) and 7(b) are views illustrating the process shown in FIGS. 6(a) to 6(c) when the semicircular member is formed in more detail.

FIG. 8 is a flowchart showing the processes of manufacturing the cylinder tube shown in FIGS. 5(a) to 5(e), etc.

FIGS. 9(a) to 9(e) are diagrams illustrating showing the pressure distribution of a part in proximity to a port hole in cylinder tubes.

FIGS. 10(a) and 10(b) are perspective views showing the structures of a cylinder tubes according to other embodiments of the present invention.

FIGS. 11(a) to 11(c) are perspective views showing processes of manufacturing a cylinder tube according to still another embodiment of the present invention.

FIG. 12 is a flowchart showing the processes of manufacturing the cylinder tube shown in FIG. 11(c).

FIGS. 13(a) and 13(b) are perspective views showing the structures of a cylinder tubes according to still other embodiments of the present invention.

### DESCRIPTION OF EMBODIMENTS

### First Embodiment

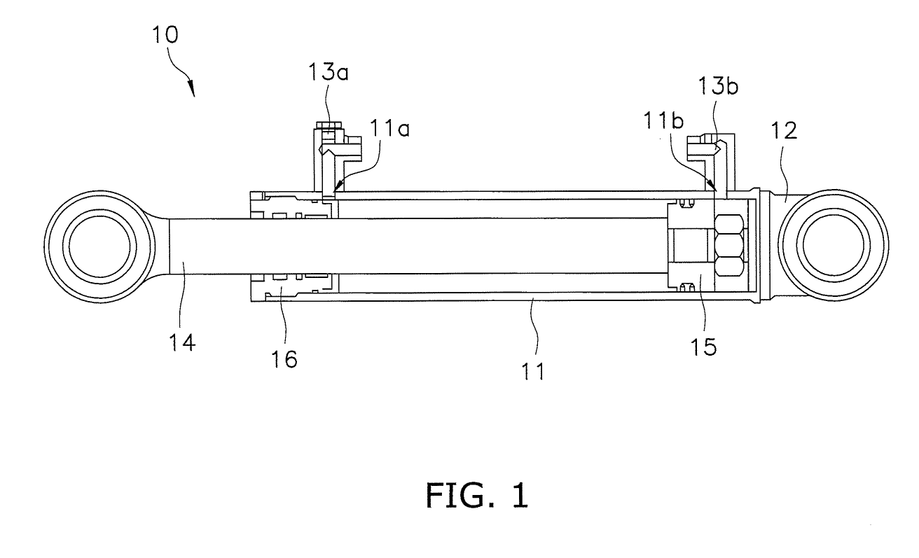

With reference to FIGS. 1 to 8, the following description will describe a hydraulic cylinder 10 including a cylinder tube 11 according to an embodiment of the present invention.

### Construction of Hydraulic Cylinder 10

The hydraulic cylinder 10 according to this embodiment includes the cylinder tube 11, a cylinder bottom (bottom member) 12, branch tubes 13a and 13b, a cylinder rod 14, a piston 15, and a cylinder head 16, as shown in FIG. 1.

The cylinder tube 11 is a cylindrical steel tube. Port holes 11a and 11b are formed on the outer peripheral surface (outer peripheral wall portion) of the cylinder tube 11, and communicate with the interior space of the cylinder tube 11. Also, the openings on the both the ends of the cylinder tube 11 are closed by the cylinder bottom 12, the cylinder rod 14, and the like. The specific construction and manufacturing method of the cylinder tube 11 will be discussed in detail later.

The cylinder bottom 12 is integrally secured to one of the ends of the cylinder tube 11 by welding.

The branch tubes 13a and 13b are formed of the same steel material as the cylinder tube 11, and are connected to the port holes 11a and 11b, respectively.

The piston 15 is arranged on one end of the cylinder rod 14 to be accommodated in the cylinder tube 11.

The piston 15 is fastened to the one end of the cylinder rod 14, which passes through the cylinder head 16, and is accommodated in the cylinder tube 11 so as to slidably reciprocate inside the cylinder tube 11.

### Construction of Cylinder Tube 11

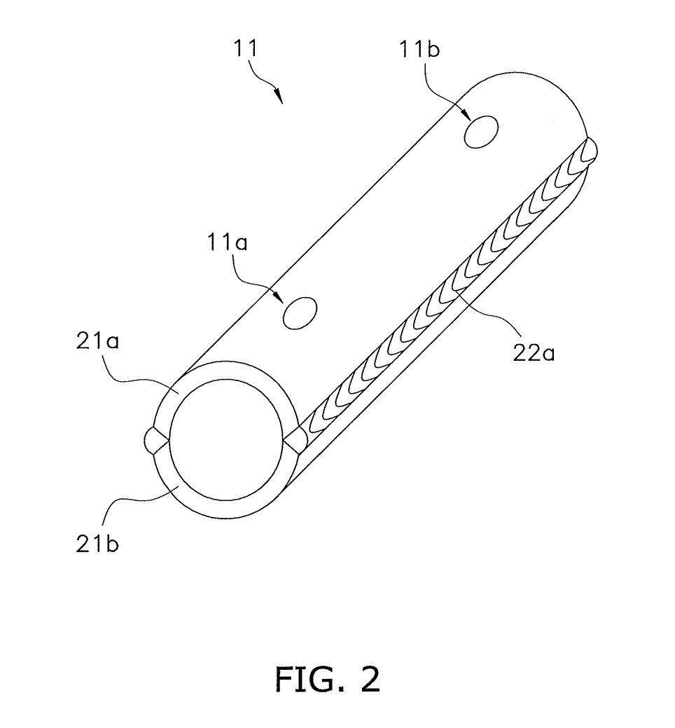

As shown in FIG. 2, the cylinder tube 11 has the port holes 11a and 11b, which are aligned along the longitudinal direction on the outer peripheral surface. The aforementioned branch tubes 13a and 13b are secured encompassing the port holes 11a and 11b, respectively. The cylinder tube 11 is formed in a substantially cylindrical shape by coupling substantially semicircular members (outer peripheral wall portion) 21a and 21b to each other.

Here, the cylinder tube 11 is a steel tube that has a length of 600 mm, an outer diameter of 80 mm, and a thickness of 6.0 mm, and is formed from steel plates.

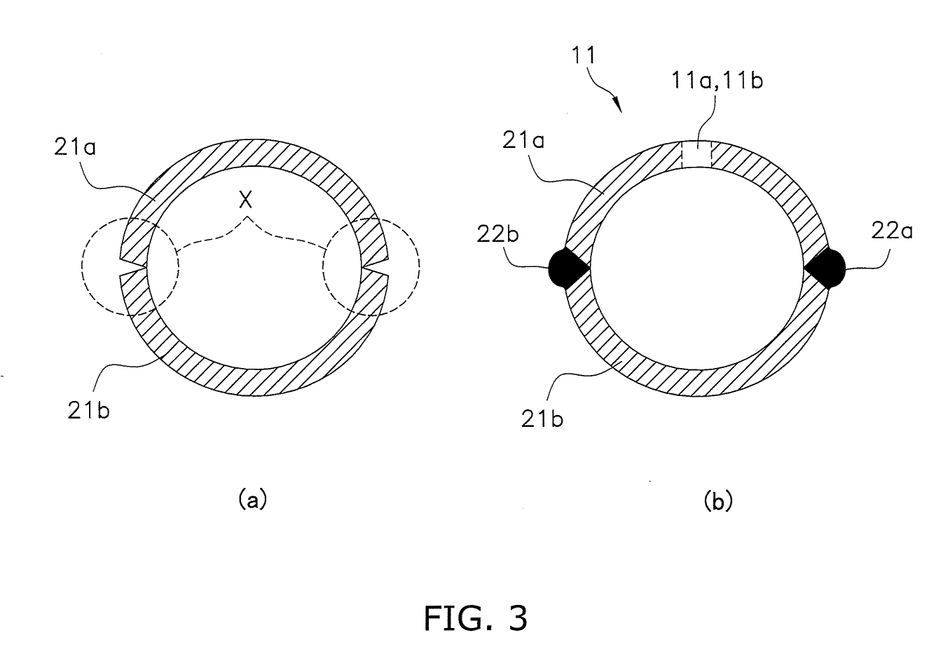

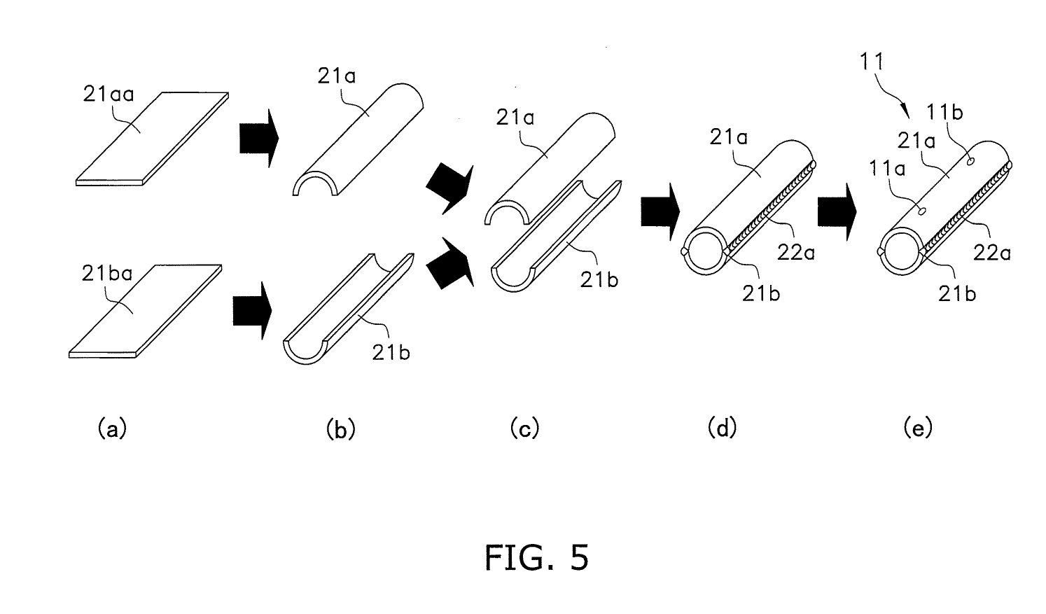

The semicircular members 21a and 21b, which have a substantially semicircular shape in section, are joined to each other by welding with their edges being in contact with each other as shown in FIG. 3(a). The semicircular members 21a and 21b are formed into a substantially semicircular shape in section by subjecting steel plates (JIS G3106 SM570) 21aa and the 21ba to presswork (see FIGS. 5(a) and 5(b)). As shown in FIG. 3(a), when the semicircular members 21a and 21b are opposed to each other, beveling parts (beveling angle of 5 degrees) are formed in coupling parts X. When the beveling parts are welded by performing plasma welding along the beveling parts, as shown in FIG. 3(b), welding beads (the rigidity changing portions, thicker portions) 22a and 22b are formed along the coupling parts.

The welding beads 22a and 22b are formed thicker than the thickness of the steel tube of the semicircular members 21a and 21b by adding a material along the coupling parts X in where beveling parts are formed. The cylinder tube 11 is partially improved in cross-sectional rigidity in parts where the welding beads 22a and 22b are formed as viewed in section. The welding beads 22a and 22b are arranged at positions spaced away from the port holes 11a and 11b as viewed in section at approximately 90 degrees in circumferential direction with respect to the port holes 11a and 11b, respectively.

The following description will describe deformation of the cylinder tube when an internal pressure is applied to this cylinder tube 11 in comparison with a conventional cylinder tube 91.

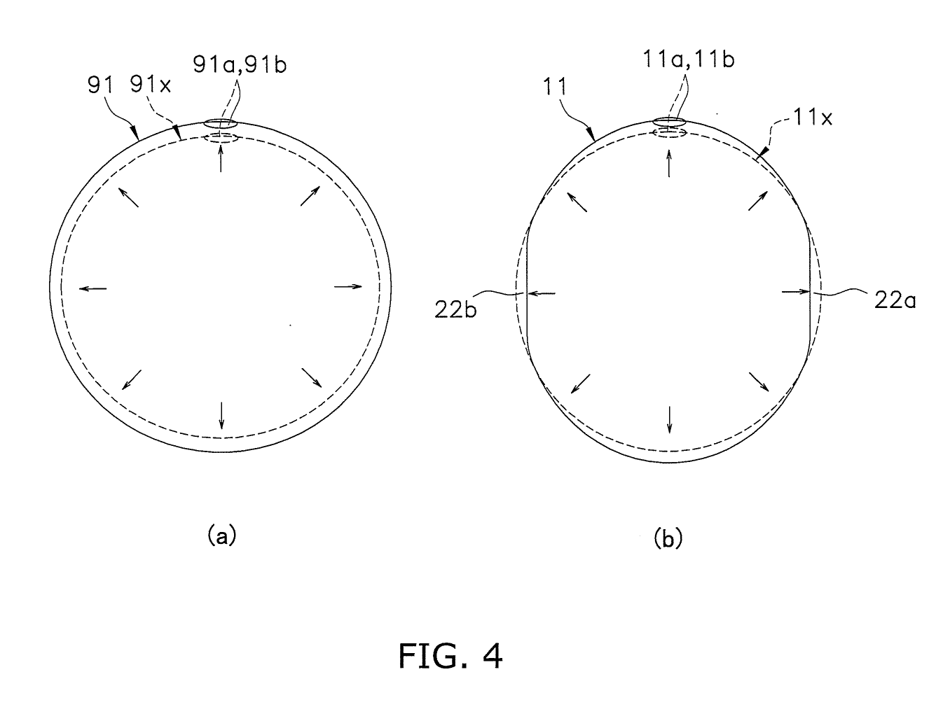

That is, as shown in FIG. 4(a), the conventional cylinder tube 91 has a substantially perfectly circular shape, and will uniformly expand so that a shape 91x shown by the dotted line expands to a shape shown by the solid line when an internal pressure of 26 MPa is applied (see the arrows in the Figure). Accordingly, a thus-produced tensile stress may cause appearance of cracks and the like in areas on the inner periphery side where the port holes 91a and 91b are formed.

Contrary to this, as shown in FIG. 4(b), the cylinder tube 11 according to this embodiment deforms from a substantially perfectly circular shape 11x shown by the dotted line to an oval shape shown by the solid line when an internal pressure is applied. At this time, since parts of the welding beads 22a and 22b in the cylinder tube 11 have a larger cross-sectional rigidity, the parts are less likely to deform as viewed in section. For this reason, from viewpoint of the entire cylinder tube 11, the cylinder tube 11 largely deform particular in the parts in proximity to the port holes 11a and 11b that are formed at positions of approximately 90 degrees in the circumferential direction with respect to the welding beads 22a and 22b. As a result, the cylinder tube 11 deforms into an oval shape.

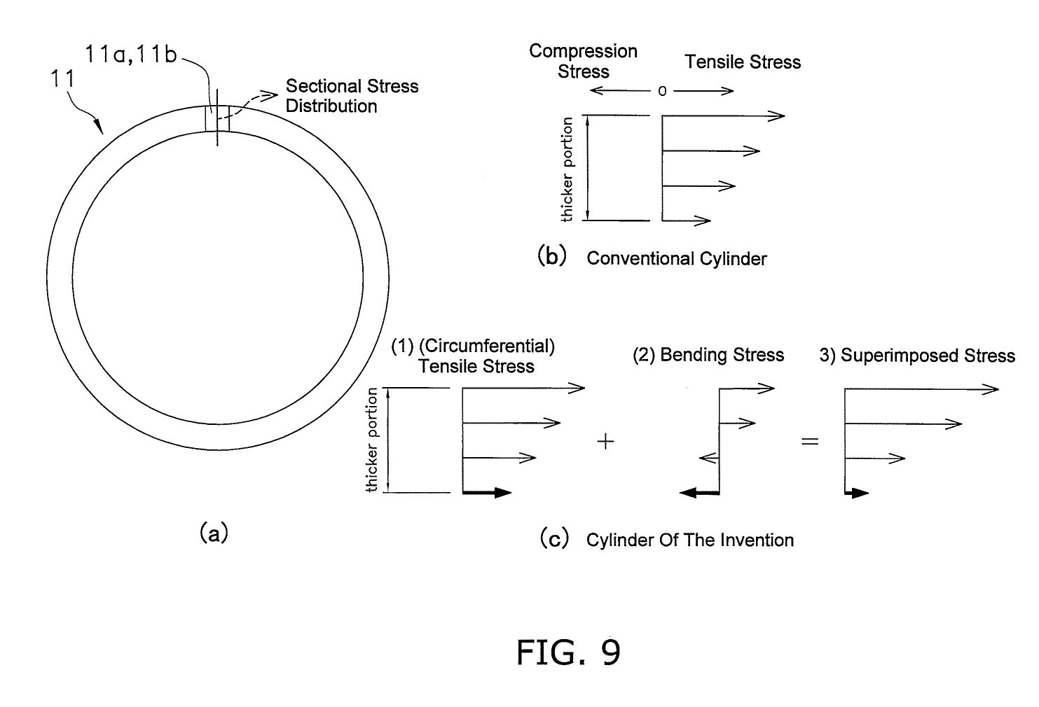

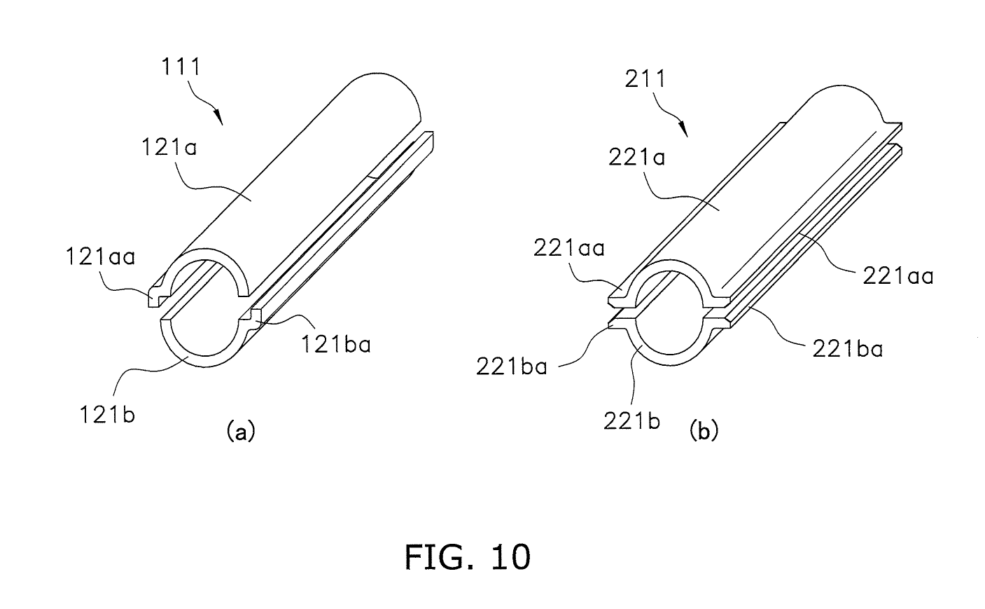

FIGS. 9(b) and 9(c) schematically show the cross-sectional stress distributions in parts in proximity to the port holes 11a and 11b of the cylinder tube 11 (see FIG. 9(a)). FIG. 9(b) shows the stress distribution of the cylinder tube that does not include the rigidity changing portion, and has a uniform thickness in the circumferential direction. When an internal pressure acts on the cylinder tube 11, a tensile stress is produced in the circumferential direction over the whole area of the cylinder tube 11. FIG. 9(c) shows the stress distribution of the cylinder tube that includes the welding beads (rigidity changing portions) 22a and 22b according to this embodiment. In the case where the cylinder tube includes the two welding beads (rigidity changing portions) 22a and 22b, when an internal pressure is applied, a tensile stress is produced by uniform expansion of the cylinder tube 11, and a bending stress is produced by deformation of the cylinder tube 11 into an oval shape. As a result, the cross-sectional stress distribution is obtained by superimposing the tensile stress and the bending stress. The cross-sectional stress distribution shown in FIG. 9(c) will be described resolved into the tensile and bending stress distributions for the sake of convenience.

The distribution (1) corresponds to a tensile stress when the cylinder tube circumferentially uniformly deforms. The distribution (2) corresponds to a bending stress when the cylinder tube deforms into an oval shape. Specifically, although a tensile stress is applied on the outer periphery side of the cylinder tube 11, the tensile stress gets smaller toward the inner side of the cylinder tube 11 so that a compression stress appears on the inner side of the cylinder tube 11. As a result, the inner side of the cylinder tube 11 is subjected to a compression stress. The distribution (3) corresponds to superposition of the stress distributions (1) and (2). Accordingly, the distribution (3) shows cross-sectional stress distribution of the cylinder tube 11 according to this embodiment when an internal pressure is applied. That is, since the bending stress, which is produced when the cylinder tube deforms into an oval shape, acts on the stress distribution of the cylinder tube shown in FIG. 9(b), the tensile stress can be reduced on the inner periphery side of the cylinder tube 11. In other words, since a compression stress resulting from the bending stress is produced in parts on the inner periphery side of the port holes 11a and 11b, the tensile stress is relieved in the parts.

In addition, FIG. 9(c) shows that a tensile stress is increased in the outer peripheral parts of the port holes 11a and 11b of the cylinder tube 11. However, as discussed above, since the outer peripheral part of the cylinder tube 11 can be chamfered by a grinder or the like, it is possible to remove a part where a stress concentratedly is produced in the outer peripheral part of the cylinder tube 11. For this reason, it is particularly important for fatigue strength control to reduce a tensile stress in the inner periphery parts of the port holes 11a and 11b as shown in FIG. 9(c).

Consequently, since the tensile stress is relieved that is produced in the part on the inner periphery sides of the port holes 11a and 11b of the cylinder tube 11, it is possible to effectively prevent that cracks and the like appear.

### Method of Manufacturing Cylinder Tube 11

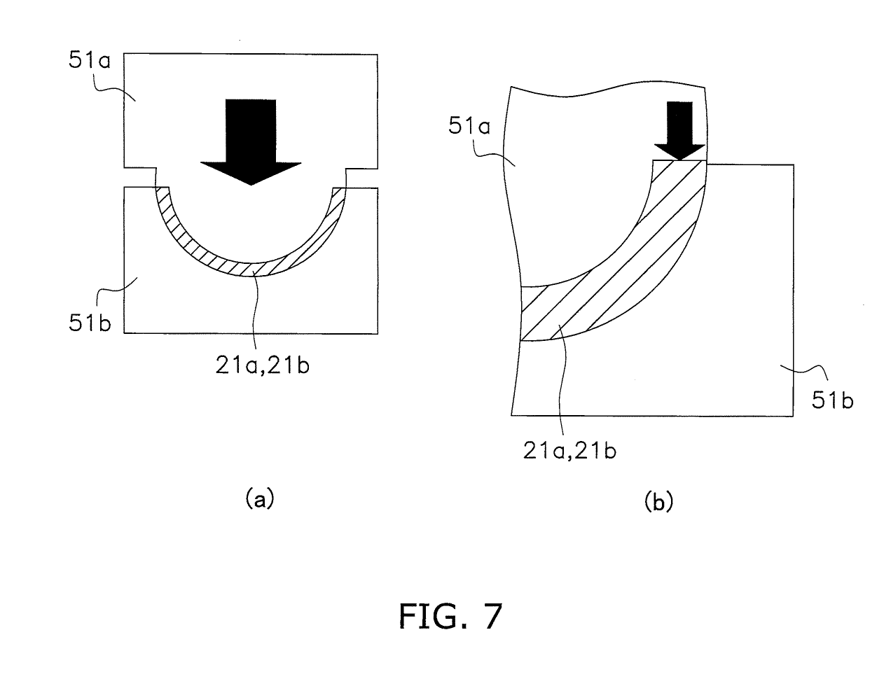

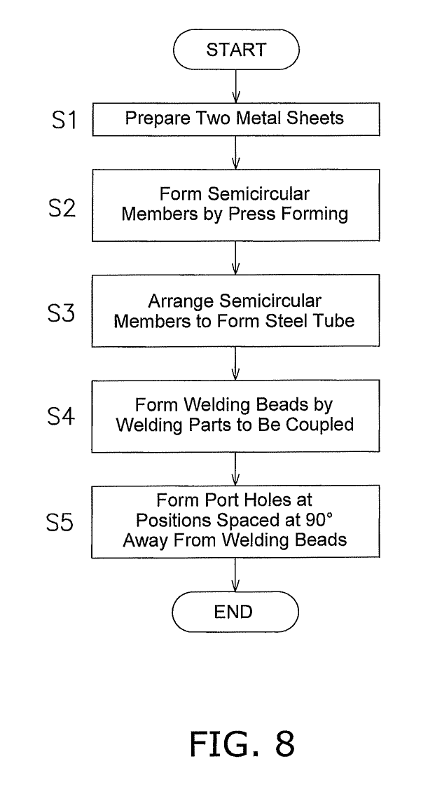

The following description will describe a method of manufacturing the aforementioned cylinder tube 11 with reference to FIGS. 5(a) to 7(b), and a flowchart of FIG. 8.

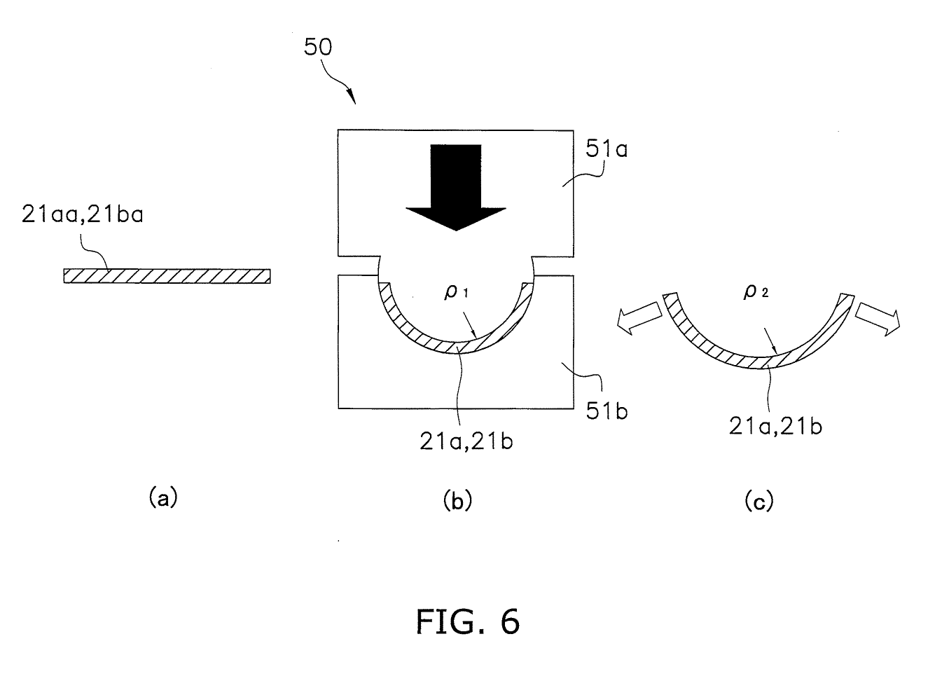

In Step S1, as shown in FIGS. 5(a) and 6(a), two steel plates 21aa and 21ba made from JIS G3106 SM570 are prepared.

In Step S2, as shown in FIGS. 5(b) and 6(b), the steel plates 21aa and 21ba are placed between upper and lower dies 51a and 51b of a press 50 so that the substantially sectionally semicircular members 21a and 21b are formed by presswork.

In addition, although the semicircular members 21a and 21b formed with the curved surface part of a curvature ρ1 of the press 50, the curvature of the semicircular members 21a and 21b will decrease to a curvature ρ2 after the semicircular members 21a and 21b are removed from the dies (springback). In order to minimize the spring back curvature decrease, in the presswork shown in FIG. 7(a), the ends of the steel plates (workpieces) 21aa and 21ba are pressed as shown in FIG. 7(b). Accordingly, it is possible to effectively prevent the spring back of the semicircular members 21a and 21b after the semicircular members 21a and 21b are removed from the dies.

In Step S3, as shown in FIG. 5(c), the semicircular members 21a and 21b are placed at upper and lower positions, and are opposed to each other to form one steel tube. Thus, the beveling parts are formed in the coupling parts X.

In Step S4, as shown in FIG. 5(d), a material is added onto the beveling parts of the aforementioned coupling parts X by performing plasma welding along the beveling parts with the semicircular members 21a and 21b being opposed to each other. Thus, the welding beads 22a and 22b are formed.

Welding conditions can be given for joining the semicircular member 21a and the 21b to each other by welding to form the cylinder tube 11.
Current Value: 200 A
Welding Speed: 20 cm/min
Wire: φ 1.2 mm
Wire Feeding Rate: 1.5 m/min
Pilot Gas: Ar Gas Mixed with H₂ Gas of 7% (Flow Rate: 2.0 l/min)
Shielding Gas: Ar of 10 l/min
Standoff (Distance between Workpiece and Torch Electrode): 3.5 mm

Finally, in Step S5, the port holes 11a and 11b are formed at the positions on the semicircular member 21a that are spaced at approximately 90 degrees in circumferential direction away from the welding beads 22a and 22b, respectively. Thus, the welding beads 22a and 22b as the rigidity changing portions can be arranged at the positions on the steel tube outer peripheral surface, which are spaced at the same interval leftward and rightward away from the port holes 11a and 11b.

### Features of Cylinder Tube 11

(1) In the cylinder tube 11 according to this embodiment, as shown in FIG. 3(b), the welding beads 22a and 22b as the rigidity changing portions for changing cross-sectional rigidity are arranged at the positions that are spaced away from the port holes 11a and 11b formed on the outer peripheral surface of the cylinder tube 11 at an interval with respect to the port holes 11a and 11b as viewed in section.

Thus, when an internal pressure is produced in the cylinder 11 tube, the cylinder tube 11 can be intendedly deformed into an oval shape in section. Accordingly, it is possible to reduce a tensile stress in the inner peripheral parts around of the port holes 11a and 11b. As a result, it is possible to control deformation of the cylinder tube into an oval shape when an internal pressure is applied without directly reinforcing the parts in proximity to the port holes 11a and 11b in which cracks and the like are likely to appear when an internal pressure is produced. Consequently, it is possible to indirectly reinforce the inner peripheral parts around the port holes 11a and 11b. Therefore, it is possible to effectively improve the fatigue strength of the cylinder tube 11.

(2) The cylinder tube 11 according to this embodiment is formed by joining the semicircular members 21a and 21b to each other by welding as shown in FIG. 2, etc.

Accordingly, when the welding beads 22a and 22b are arranged at the position spaced at approximately 90 degrees in the circumferential direction with respect to the port holes 11a and 11b and are left as they are, it is possible to change the cross-sectional rigidity of the cylinder tube. Therefore, it is possible to provide the cylinder tube 11 with the distribution of stress where a tensile stress is reduced in the inner peripheral parts around the port holes 11a and 11b.

(3) In the cylinder tube 11 according to this embodiment, as shown in FIG. 3(b), the welding beads 22a and 22b are arranged and serve as thicker portions as the rigidity changing portion that has a larger thickness than the thickness of the steel tube and protruding toward the outer diameter side.

Accordingly, even when an internal pressure is produced in the cylinder tube 11, the cylinder tube 11 can deform into an oval shape in section so that a stress is relieved in the parts around the port holes 11a and 11b. As a result, it is possible to prevent that a large tensile stress is produced on the inner periphery side of the port holes 11a and 11b so that cracks and the like appear. Therefore, it is possible to improve the fatigue strength of the cylinder tube 11.

(4) In the cylinder tube 11 according to this embodiment, as shown in FIG. 3(b), etc., the welding beads 22a and 22b are formed by the welding process, and are left as they are. As a result, the welding beads 22a and 22b can serve as the rigidity changing portions.

Accordingly, since the rigidity changing portions can be formed without an additional process, it is possible to increase the efficiency of the manufacturing method.

(5) In the cylinder tube 11 according to this embodiment, as shown in FIG. 3(b), the welding beads 22a and 22b as the rigidity changing portions are joined to the outer peripheral surface of the cylinder tube 11 with the surface of the welding beads 22a and 22b being smoothly curved.

Accordingly, it is possible to avoid that a stress is concentratedly produced in parts between the welding beads 22a and 22b, and the outer peripheral surface of the cylinder tube 11, which in turn causes appearance of cracks and the like when an internal pressure occurs, or when an external force is applied, for example.

(6) In the cylinder tube 11 according to this embodiment, as shown in FIG. 3(b), etc., the welding beads 22a and 22b as the rigidity changing portions are arranged at positions spaced at approximately angles of 90 degrees away from the port holes 11a and 11b as viewed in section, respectively.

Accordingly, it is possible to deform the cylinder tube into an oval shape in section so that a compression stress is produced in the inner peripheral parts in proximity to the port holes 11a and 11b when an internal pressure is produced. Therefore, it is possible to prevent that cracks appear on the parts in proximity to the port holes 11a and 11b, and to improve the fatigue strength of the cylinder tube 11.

(7) The hydraulic cylinder 10 according to this embodiment includes the aforementioned cylinder tube 11 and the cylinder bottom 12, as shown in FIG. 1.

Accordingly, it is possible to provide the hydraulic cylinder 10, which includes the aforementioned cylinder tube 11 the fatigue strength of which is improved as stated above.

(8) The method of manufacturing the cylinder tube 11 according to this embodiment includes a step for forming the semicircular members 21a and 21b by subjecting the flat steel plates 21aa and 21ba by press forming; a step for arranging the semicircular members 21a and 21b opposed to each other to form a cylindrical pipe member; a step joining the semicircular members 21a and 21b to each other by welding with the semicircular members 21a and 21b forming the cylindrical pipe member; and a step for forming the port holes 11a and 11b at the predetermined positions on the outer peripheral surface of the semicircular member 21a, as shown in FIG. 8.

Accordingly, after the welding beads 22a and 22b are formed by welding the semicircular members 21a and 21b to each other with the semicircular members 21a and 21b being opposed to each other, the welding beads 22a and 22b are only left as they, which in turn allows the welding beads 22a and 22b to serve as the rigidity changing portions, which partially change the cross-sectional rigidity of the cylinder tube. As a result, when an internal pressure is produced, the cylinder tube 11 can deform into an oval shape that can reduce a tensile stress in the inner peripheral parts around the port holes 11a and 11b. Therefore, it is possible to provide the cylinder tube 11 with improved fatigue strength.

### Second Embodiment

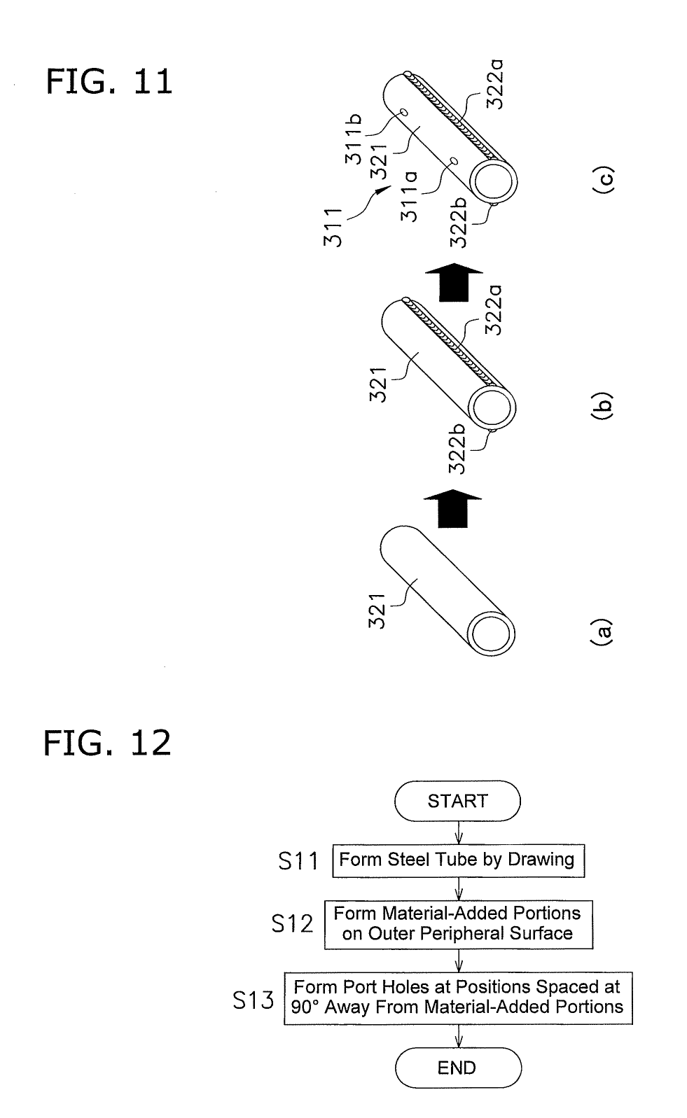

The following description will describe a cylinder tube 311 according to another embodiment of the present invention with reference to FIGS. 11(a) to 11(c), and 12.

The cylinder tube 311 according to this embodiment is similar to the foregoing first embodiment except that a steel tube (outer peripheral wall portion) 321 formed by drawing is used and added with a material to form welding beads 322a and 322b as the rigidity changing portions on the outer peripheral surface of the steel tube 321.

### Construction of Cylinder Tube 311

The cylinder tube 311 includes port holes 311a and 311b at predetermined positions of the steel tube 321, as shown in FIG. 11(c). The welding beads 322a and 322b are arranged at positions on the outer peripheral surface of the steel tube 321 that are spaced at approximately 90 degrees away from the port holes 311a and 311b.

### Method of Manufacturing Cylinder Tube 311

The following description will describe a method of manufacturing the cylinder tube 311.

In Step S11, as shown in FIG. 11(a), the steel tube 321 formed by drawing is prepared.

In Step S12, as shown in FIG. 11(b), a material is then added onto the outer peripheral surface of the steel tube 321 so that the welding beads 322a and 322b are formed. It is preferable that the welding beads 322a and 322b be formed at positions on the outer peripheral surface that are spaced leftward and rightward at approximately 90 degrees away from the port holes 311a and 311b, which will be formed in the next process (Step S13), respectively.

Finally, in Step S13, the port holes 311a and 311b are formed at the positions on the outer peripheral surface of the steel tube 321 that are spaced at approximately 90 degrees away from the welding beads 322a and 322b as shown in FIG. 11(c).

Accordingly, similar to the cylinder tube 11 according to the foregoing first embodiment, when an internal pressure is produced in the cylinder 311 tube, the cylinder tube 311 can be intendedly deformed into an oval shape in section. In this deformation, since a compression stress is produced by bending, it is possible to reduce a tensile stress in the inner peripheral parts around of the port holes 311a and 311b. As a result, it is possible to control deformation of the cylinder tube into an oval shape when an internal pressure is applied without directly reinforcing the parts in proximity to the port holes 311a and 311b, or the like. Therefore, it is possible to effectively improve the fatigue strength of the cylinder tube 311.

That is, dissimilar to the foregoing first embodiment in which the welding beads 22a and 22b are formed when the semicircular members 21a and 21b are joined to each other by welding and are used as they are, in this embodiment, welding wire is melted at the predetermined positions on the outer peripheral surface of the steel tube 321 formed by drawing or the like to form the material-added portions (welding beads 322a and 322b), which in turn can provide an effect similar to the foregoing first embodiment.

The method of manufacturing the cylinder tube 11 according to this embodiment includes a step for forming the steel tube 321 by drawing (Step S11); a step for forming a material-added portion on the outer peripheral surface of the steel tube 321 (Step S12); and a step for forming the port holes 311a and 311b at the predetermined positions on the outer peripheral surface of the cylinder tube 321 (Step S13), as shown in FIG. 12.

Thus, the welding beads 322a and 322b formed by adding a material onto the outer peripheral surface of the steel tube 321 can be used as the rigidity changing portions, which partially change the cross-sectional rigidity of the steel tube 321. As a result, when an internal pressure is produced, the cylinder tube 311 can be indendedly deformed into an oval shape that can reduce a tensile stress in the inner peripheral parts around the port holes 311a and 311b. Therefore, it is possible to provide the cylinder tube 311 with improved fatigue strength.

### Other Embodiments

The above description has described exemplary embodiments according to the present invention. However, the present invention is not limited to the foregoing embodiments. Various changes and modifications can be made without departing from the spirit of the present invention.

(A) In the foregoing embodiment, the welding beads 22a and 22b have been illustratively described that are formed in the welding/coupling process to serve as the rigidity changing portions that allow the cylinder tube 11 to deform into an oval shape in section. However, the present invention is not limited to this construction.

For example, as shown in FIG. 9(a), a cylinder tube 111 can have stepped bending portions 121aa and 121ba that are arranged one-side ends of the semicircular members (outer peripheral wall portions) 121a and 121b, respectively. In this case, when the stepped bending portion 121aa and 121ba are opposed to and are joined by welding to the other side ends of the semicircular members, the welded parts including the stepped bending portions 121aa and 121ba can be used as the rigidity changing portions.

In addition, as shown in FIG. 9(b), a cylinder tube 211 can have stepped bending portions 221aa and 221ba that are arranged both side ends of the semicircular members (outer peripheral wall portions) 221a and 221b, respectively. In this case, when the stepped bending portions 221aa and 221ba are opposed to each other and are joined by welding to the other by welding beveling parts formed in parts to be joined between the stepped bending portions 221aa and 221ba, the welded parts including the stepped bending portions 221aa and 221ba can be used as the rigidity changing portions.

(B) In the foregoing embodiment, the welding beads 22a and 22b have been illustratively described that have cross-sectional rigidity larger than the other parts of the cylinder tube and serve as the elasticity variation portions that can reduce a tensile stress in the inner peripheral part around of the port holes 11a and 11b when an internal pressure is produced. However, the present invention is not limited to this construction.

For example, when the steel tube is formed, the thickness of a part in proximity to the port hole may be reduced so that a tensile stress is reduced in the inner peripheral part of the port hole. That is, the thickness of parts spaced away from the port hole is not increased, but the thickness of a part in proximity to the port hole is reduced so that the part in proximity to the port hole has cross-sectional rigidity lower than the other parts of the steel tube.

Similar to the foregoing embodiment, in this case, the steel tube can also deform into an ovals shape so that a tensile stress is reduced in the inner peripheral part of the port hole when an internal pressure is produced. As a result, it is possible to prevent that cracks appear. Therefore, it is possible to provide a cylinder tube with improved fatigue strength.

(C) In the foregoing embodiment, the cylinder tube 11 has been illustratively described that is formed by coupling the two semicircular members 21a and 21b to each other. However, the present invention is not limited to this construction.

For example, when a steel tube is formed, the rigidity changing portion with larger thickness may be formed at a position spaced away from the port hole as viewed in section.

Also, in this case, it is possible to control deformation of the steel tube into an oval shape when an internal pressure is produced. Therefore, it is possible to provide a cylinder tube with improved fatigue strength.

(D) In the foregoing embodiment, the semicircular members 21a and 21b of the cylinder tube 11 have been illustratively described that are formed by subjecting the steel plates 21aa and 21ba to presswork. However, the present invention is not limited to this construction.

For example, the semicircular member may be formed by metal molding.

However, presswork of flat plate is preferable from viewpoint of manufacturing cost, and the like.

(E) In the foregoing embodiment, the two welding beads 22a and 22b as the rigidity changing portions have been illustratively described that are spaced leftward and rightward at the same interval away from the port holes 11a and 11b as viewed in section. However, the present invention is not limited to this construction.

For example, only one welding bead as the rigidity changing portion may be arranged as viewed in section so that the cylinder tube can deform into a desired oval shape when an internal pressure is produced. Alternatively, three or more rigidity changing portions may be arranged so that the cylinder tube can deform into a desired oval shape.

(F) In the foregoing embodiment, the cylinder tube 11 has been illustratively described that is formed by coupling the semicircular members 21a and 21b to each other. However, the present invention is not limited to this construction.

For example, the cylinder tube may be formed by coupling three or more semicircular members to each other.

Alternatively, the steel tube 321 can be formed by drawing or the like and used to compose the cylinder tube 311 according to the present invention as in the foregoing second embodiment.

(G) In the foregoing embodiment, the cylinder tubes 11, 111, 211 and 311 have been illustratively described that have the welding beads 22a and 22b, and the welding beads 322a and 322b, and the like as the rigidity changing portions extending along the longitudinal direction of the steel tube. However, the present invention is not limited to this construction.

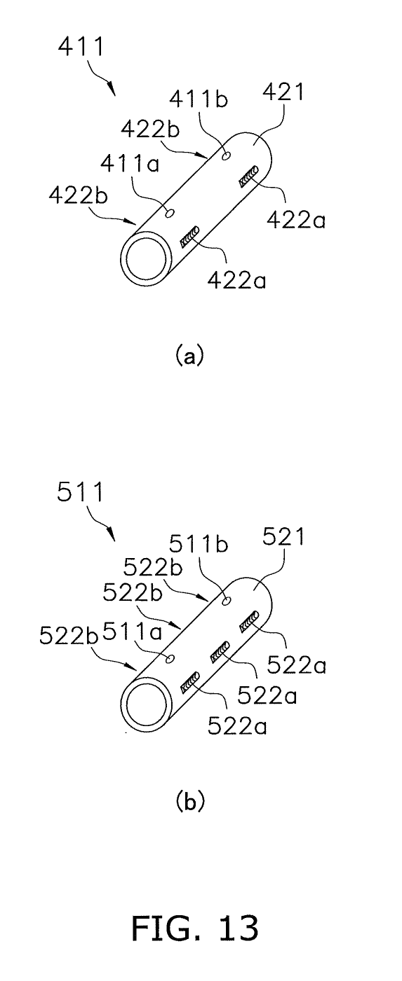

For example, welding beads 422a, 422b, 522a, 522b, and the like may be used as rigidity changing portions that are intermittently formed along the longitudinal direction of the steel tubes (outer peripheral wall portions) 421 and 521 formed by drawing, or the like, as shown in FIGS. 13(a) and 13(b).

In this case, where the welding beads 422a, 422b, 522a, 522b etc., are intermittently formed along the longitudinal direction of the steel tubes 421 and 521, it is preferable that they be formed at least at positions spaced leftward and rightward at approximately 90 degrees in the circumferential direction away from to the port holes 411a, 411b, 511a, and 511b.

Thus, the cylinder tubes 411 and 511 can be intendedly deformed into an oval shape when an internal pressure is produced. As a result, it is possible to reduce a tensile stress in the inner peripheral parts of the port holes 411a, 411b, 511a, and 511b. Therefore, it is possible to provide the cylinder tube 411 and 511 with improved fatigue strength.

A cylinder tube according to the illustrated embodiments can be intendedly deformed into a desired oval shape when an internal pressure is produced so that a stress can be relieved in a part in proximity to a port hole, which in turn reduces appearance of cracks and the like. Therefore, the cylinder tube has an effect that the fatigue strength of the cylinder tube is improved. For this reason, the cylinder tube can be widely applied to hydraulic cylinders for various types of devices.

1. A cylinder tube of a hydraulic cylinder comprising:
a substantially cylindrical outer peripheral wall portion;
a port hole that is formed in a part of the outer peripheral wall portion to communicate with an interior space of the outer peripheral wall portion; and
a plurality of rigidity changing portions arranged at positions spaced at about 90 degrees leftward and rightward away from the port hole in the circumferential direction as viewed in section, with each of the rigidity changing portions having cross-sectional rigidity larger than a part in proximity to the port hole.

2. The cylinder tube according to claim 1, wherein
each of the rigidity changing portions is a thicker portion that has a larger thickness increasing toward a radially outer side in the outer peripheral wall portion, and extends along the longitudinal direction of the cylinder tube.

3. The cylinder tube according to claim 1, wherein
each of the rigidity changing portions includes a welding bead that is formed on an outer peripheral surface of the outer peripheral wall portion along the longitudinal direction of the cylinder tube.

4. (canceled)

5. The cylinder tube according to claim 1, wherein
each of the rigidity changing portions is formed in a smoothly-curved shape as viewed in section.

6. The cylinder tube according to claim 1, wherein
the outer peripheral wall portion is formed by coupling sectionally substantially semicircular members to each other by welding.

7. The cylinder tube according to claim 6, wherein
each of the rigidity changing portions is a stepped bending portion that is formed in a bended shape on a coupled part of the sectionally substantially semicircular members.

8. The cylinder tube according to claim 1, wherein
the outer peripheral wall portion is formed from a steel tube that is formed by drawing.

9. The cylinder tube according to claim 8, wherein
each of the rigidity changing portions is intermittently formed along the longitudinal direction of the steel tube.

10. (canceled)

11. The cylinder tube according to claim 8, wherein
each of the rigidity changing portions is formed in a smoothly-curved shape as viewed in section.

12. A hydraulic cylinder comprising:
the cylinder tube according to claim 1, and
a bottom member that is secured to one end of the cylinder tube by welding.

13. A hydraulic cylinder comprising:
the cylinder tube according to claim 8, and
a bottom member that is secured to one end of the cylinder tube by welding.

14. A method of manufacturing a cylinder tube of a hydraulic cylinder having a port hole, the method comprising:
forming a flat plate-shaped material into a sectionally substantially semicircular member;
arranging two of the sectionally substantially semicircular members to form a pipe-shaped member;
coupling the sectionally substantially semicircular members arranged to form a pipe-shaped member to each other by welding; and
forming the port hole at a position spaced in the circumferential direction away from parts of the substantially semicircular members coupled to each other by welding.

15. A method of manufacturing a cylinder tube of a hydraulic cylinder having a port hole, the method comprising:
forming a steel tube by drawing;
forming a rigidity changing portion at a predetermined position on the steel tube; and
forming the port hole at a position on an outer peripheral surface of the steel tube spaced in the circumferential direction away from the rigidity changing portion.
